(19) United States
(12) Patent Application Publication
(10) Pub. No.: US 2021/0251432 A1
(43) Pub. Date: Aug. 19, 2021

(54) Infrared Radiant Heating Delivery Container

(71) Applicant: GM GLOBAL TECHNOLOGY OPERATIONS LLC, Detroit, MI (US)

(72) Inventors: Kuo-huey CHEN, Troy, MI (US); Chih-hung Yen, Bloomfield Hills, MI (US); Taeyoung Han, Bloomfield Hills, MI (US); Bahram Khalighi, Birmingham, MI (US); Paul E. Krajewski, Troy, MI (US)

(21) Appl. No.: 16/790,303

(22) Filed: Feb. 13, 2020

(51) Int. Cl. A47J 47/14; B65D 81/38; B65D 81/18; A47J 41/00

(52) U.S. Cl. CPC A47J 47/14; B65D 81/3813; A47J 41/0066; A47J 41/005; B65D 81/18

(57) ABSTRACT

A container for heating an object. The container comprises a top surface, a bottom surface, and a plurality of side surfaces. The top surface, the bottom surface, and the plurality of side surfaces define an interior of the container in which the object is placed. The container further comprises a heating shell associated with at least one of the side surfaces, the top surface, or the bottom surface, the heating shell configured to radiate heat into the interior of the container, and a temperature control module configured to control the amount of heat radiated by the heating shell.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

Portable insulated containers are widely used to deliver products that must be kept warm, such as food deliveries to customers' homes. However, insulated containers have significant problems. Even the most well insulated containers do not provide a uniform thermal environment and are incapable of keeping food warm for a long period.

### SUMMARY

It is an aspect of the present disclosure to provide a container for heating an object comprising: i) a top surface; ii) a bottom surface; iii) a plurality of side surfaces, wherein the top surface, the bottom surface, and the plurality of side surfaces define an interior of the container in which the object is placed; iv) a heating shell associated with at least one of the side surfaces, the heating shell configured to radiate heat into the interior of the container; and v) a temperature control module configured to control the amount of heat radiated by the heating shell.

In one embodiment, the heating shell comprises an infrared (IR) radiant heating fabric that receives electrical power from the temperature control module and generates heat therefrom.

In another embodiment, the heating shell comprises an insulation material that is outermost with respect to the interior of the container, the insulation material adapted to retain heat within the interior of the container.

In still another embodiment, the heating shell further comprises a heat transmissive cover that is innermost with respect to the interior of the container.

In yet another embodiment, the infrared radiant heating fabric is disposed between the insulation material and the heat transmissive cover.

In a further embodiment, the heating shell further comprises a reflective material disposed between the insulation material and the heat transmissive cover, wherein the reflective material reflects heat toward the interior of the container.

In a still further embodiment, the infrared radiant heating fabric is disposed between the insulation material and the reflective material.

In a yet further embodiment, the temperature control module generates a pulse width modulated (PWM) waveform, where a duty cycle of the PWM waveform controls the amount of heat radiated by the heating shell.

In an embodiment, the temperature control module further comprises a plurality of temperature setting modules, wherein a first temperature-setting module controls the amount of heat radiated by the heating shell.

In another embodiment, the container further comprises a second heating shell associated with a second one of the side surfaces, the second heating shell configured to radiate heat into the interior of the container, wherein a second temperature-setting module controls the amount of heat radiated by the second heating shell.

In still another embodiment, the temperature control module is configured to receive power from an external battery supply.

In yet another embodiment, the container further comprises a solar panel, wherein the temperature control module is configured to receive power from the solar panel.

In a further embodiment, the container further comprises an onboard battery, wherein the temperature control module is configured to receive power from the onboard battery.

It is another aspect of the present disclosure to provide a pouch for heating an object comprising: i) a non-rigid fabric material defining an interior of the pouch in which the object is placed; ii) a heating shell associated with the fabric material, the heating shell configured to radiate heat into the interior of the container; and iii) a temperature control module configured to control the amount of heat radiated by the heating shell.

In one embodiment, the heating shell comprises an infrared (IR) radiant heating fabric that receives electrical power from the temperature control module and generates heat therefrom.

In another embodiment, the heating shell comprises an insulation material that is outermost with respect to the interior of the pouch, the insulation material adapted to retain heat within the interior of the pouch.

In still another embodiment, the heating shell further comprises a heat transmissive cover that is innermost with respect to the interior of the pouch.

In yet another embodiment, the infrared radiant heating fabric is disposed between the insulation material and the heat transmissive cover.

In a further embodiment, the heating shell further comprises a reflective material disposed between the insulation material and the heat transmissive cover, wherein the reflective material reflects heat toward the interior of the pouch.

In a still further embodiment, the infrared radiant heating fabric is disposed between the insulation material and the reflective material.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates a container according to a first embodiment of the present disclosure.

FIG. 2 illustrates a container according to a second embodiment of the present disclosure.

FIG. 3 illustrates a container according to a third embodiment of the present disclosure.

FIG. 4 illustrates a container according to a fourth embodiment of the present disclosure.

In the drawings, reference numbers may be reused to identify similar and/or identical elements.

### DETAILED DESCRIPTION

The present disclosure describes a product container that incorporates an infrared (IR) radiant heating fabric that provides efficient and active heating capacity to keep objects (e.g., foods) warm. The disclosed container meets the quality or function requirements of the delivered object during the entire transportation period, whether in a vehicle or in a personal mobile unit (e.g., e-bike).

The disclosed product container generates a uniform thermal environment surrounding the heated objects and is capable of providing direction-dependent (or customized) heating, if desired, by varying the power from each surface of the container. Advantageously, the disclosed product container provides direct radiant heating off objects in the container, thereby eliminating the need to warm up the surrounding air before heating the objects. This is a more energy efficient solution.

The disclosed product container includes an active heating device that may use the power source in a vehicle, the battery pack in a mobile unit (e.g., e-bike), or a separate portable battery pack or solar cell unit associated with the disclosed product container. The disclosed product container improves customer satisfaction with the foods (objects) stored in the container, maintains the desired temperature for the foods (objects) to prevent thermal degradation due to lengthy transportation, and improves the usability of a personal mobile unit, such as an e-bike, by conveniently attaching the disclosed product container to the power source of the personal mobile unit.

For the purposes of this disclosure and the claims herein, the term “heating an object” shall include both increasing the temperature of an object as well as maintaining the temperature of an object. Thus, the disclosed container can heat an object by generating sufficient heat to raise the temperature of an object from room temperature (e.g., 25° C.) to, for example, 120° C. The disclosed container can also heat an object by generating sufficient heat to keep the temperature of the object at 120° C.

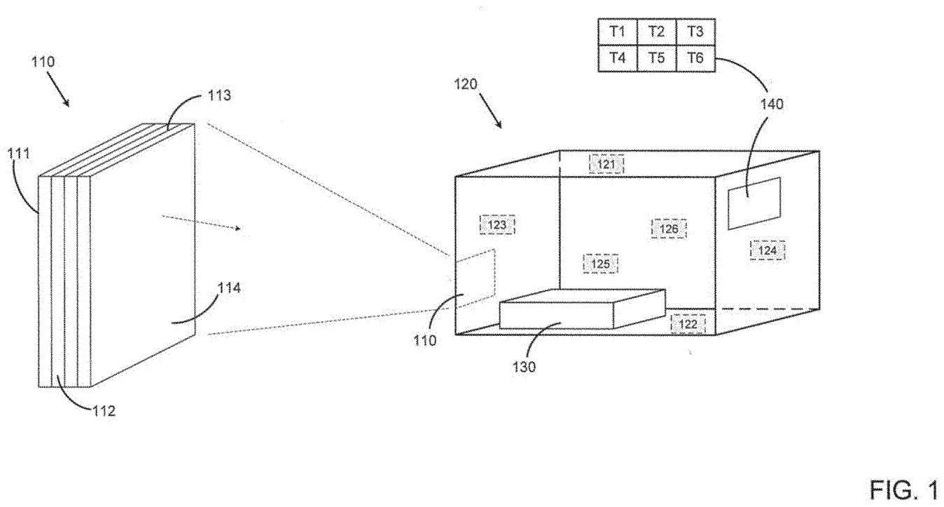

FIG. 1 illustrates a container 120 in a see-through perspective view according to a first embodiment of the present disclosure. The container comprises six surfaces 121-126, including a top surface (or lid) 121, a bottom surface 122, and four (4) side surfaces (or walls) 123-126. An object 130 that must be kept warm is disposed inside the container 120. A temperature control module 140 includes six (6) temperature-setting modules T1-T6 that control the heat that each surface 121-126 generates.

Each one of side surfaces 121-126 comprises a hard or semi-soft heating shell, such as the exemplary heating shell 110 associated with the surface 123. For simplicity, the heating shells in the other surfaces are not shown. In many embodiments, the heating shell 110 may cover all or most of the surface 123. The heating shell 110 comprises four (4) layers, including an outermost insulation material 111, a reflective material 112, an infrared (IR) radiant heating fabric 113, and an interior-facing heat transmissive cover 114. The IR radiant heating fabric 113 couples to a power source (not shown) via temperature control module 140. In an exemplary embodiment, IR radiant heating fabric 113 may comprise a woven fabric that performs as a heater. The heat transmissive cover 114 comprises a material having a low thermal mass that allows the radiant heat to pass through easily while maintaining appearance and easy cleaning.

By way of example and not limitation, IR radiant heating fabric 113 may comprise heating threads made of a strong nylon/polyester non-conductive yarn (coated with a non-metal) and a conductive carbon-compound thread. Electric feeders, made of very thin metallic threads, are woven into the fabric and connect to the power supply. Such a heating fabric provides a much uniform heating surface and provides vehicle application benefits, such as a 12 volt or higher operation, low energy consumption at 20 to 100 W for a 11″×16″ pad, and a quick surface temperature rising up to 130° Celsius in, for example, 60 seconds.

The exemplary heating shell 110 may be applied only to one of surfaces 121-126, may be applied to a plurality of surfaces 121-126, or may be applied to all six of surfaces 121-126. The heated object 130 may be surrounded by uniform heating from all directions or by any combination of non-uniform heating from selected ones of surfaces 121-126, if desired. Advantageously, the power source (not shown) may be an on-board battery pack, either in a vehicle or in personal mobile unit such as e-bike. Direction dependent heating may be achieved by varying the power from each one of surfaces 121-126.

The temperature setting modules T1-T6 control the heat generated by each one of surfaces 121-126 respectively. The values of T1 through T6 are individually selected temperature values. For example, if T1=110° C., then temperature setting module T1 sets surface 121 to 110° Celsius. Similarly, if T2=105° C., then temperature setting module T2 sets surface 122 to 105° Celsius, and so forth.

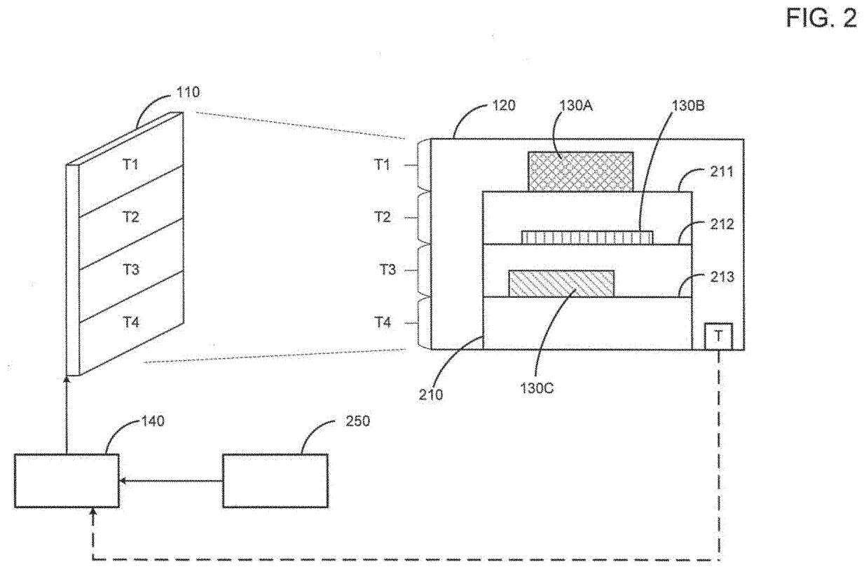

FIG. 2 illustrates the container 120 in an elevation view according to a second embodiment of the present disclosure. The container 120 further includes a rack 210 comprising a plurality of shelves, including exemplary shelves 211, 212 and 213, for supporting a plurality of objects 130A, 130B and 130C that must be kept warm. For simplicity of explanation and illustration, the temperature control module 140 is spaced apart from the surfaces of container 120 and the four layers of the heating shell 110 are not shown separately. A power source 250, which may be, for example, a vehicle battery, a portable on-board battery, a solar cell, or the like, provides power to the temperature control module 140. The temperature control module 140 in turn provides power to the heating shells 110 on one or more of the surfaces 121-126 of the container 120.

In the embodiment in FIG. 2, it is assumed that the heating shell 110 is implemented on only one side surface of the container 120. The heating shell is divided into four separately controllable temperature zones, generally designated by the temperatures T1-T4. An uppermost first zone T1 of the heating shell 110 is set to temperature T1, which warms the object 130A on the top shelf 211 of the rack 210. A second zone T2 of the heating shell 110 is set to temperature T2, which warms the object 130B on the second shelf 212 of the rack 210. A third zone T3 of the heating shell 110 is set to temperature T3, which warms the object 130C on the third shelf 211 of the rack 210. A fourth zone T4 of the heating shell 110 may be turned off, since there is no object on the bottom shelf of the rack 210.

The temperature control module 140 is capable of monitoring the temperature on each shelf 211-213 by means of at least one temperature sensor T (e.g., thermocouple) coupled by a wireline connection (e.g., dotted line) to the temperature control module 140. In an exemplary embodiment, the temperature control module 140 controls the individual temperatures T1-T4 of the zones T1-T4 using pulse-width modulated (PWM) current control signals that are applied to the individual IR radiant heating fabrics 113 in each of the separate zones T1-T4 of the heating shell 110.

Each PWM signal is a series of pulses having a controllable duty cycle. The higher the duty cycle is, the hotter the IR radiant heating fabric 113 becomes. The temperature control module 140 applies current with PWM control to the IR radiant heating fabric 113 in each zone T1-T4. For example, a 0% duty cycle (OFF) may cause the IR radiant heating fabric 113 for zone T4 to remain at ambient temperature (e.g., 30° C.) while a 100% duty cycle may cause the IR radiant heating fabric 113 for zone T1 to heat up to a temperature of 130° C. Between 30° C. and 130° C., the PWM signal may vary linearly with the target temperature.

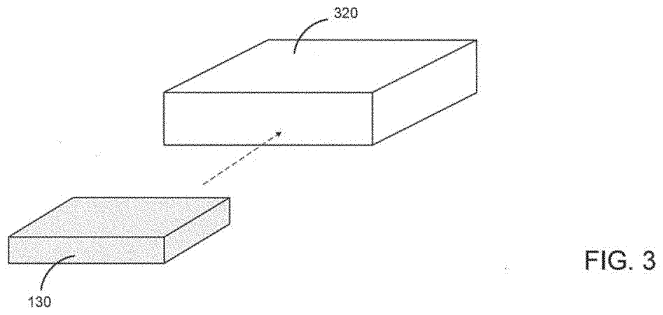

FIG. 3 illustrates a container 320 according to a third embodiment of the present disclosure. The container 320 is a pouch container into which the object 130 is inserted. One or more of the surfaces of the container 320 comprises a heating shell 110 (not shown) that includes the four (4) layers and a temperature control module 140 (not shown) as illustrated and explained above with respect to FIG. 1 and FIG. 2.

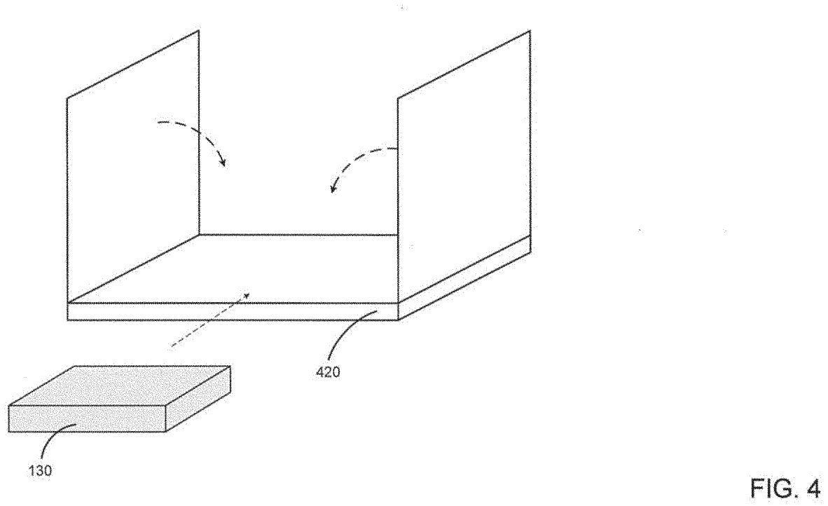

FIG. 4 illustrates a container according to a fourth embodiment of the present disclosure. The container 420 is a foldable container, such as a cardboard box or a wrapping blanket, into which the object 130 is inserted. The container 420 comprises a heating shell 110 (not shown) that includes the four (4) layers and a temperature control module 140 (not shown) as illustrated and explained above with respect to FIG. 1 and FIG. 2.

The disclosed containers 120, 320, 420 may be implemented in numerous configurations. For a hard surface box wall, the heating shell may comprises a laminated insulation, a Mylar reflection layer, a heating fabric layer, and a clear heat transmissive material. For a soft (semi-flexible) container, the heating shell may comprise a laminated insulation layer, a Mylar reflection layer, a heating fabric, and a soft touch cover material.

Those skilled in the art will understand that the container 120 in FIG. 1 is not limited to having six (6) surfaces, namely a top surface, a bottom surface, and four (4) side surfaces (or walls). In alternate embodiments, container 120 may have a triangular cross-section formed by only three (3) side surfaces. In still other embodiments, container 120 may have more than four side surfaces, such as a hexagonal cross-section formed by six (6) sidewalls.

The disclosed container provides delivery companies with the ability to deliver, for example, heated food packages to customers and the flexibility to use either driver-operated vehicles or autonomous vehicles or both. For example, if multiple foods are delivered to a single customer, the separate food items may be delivered in an individual pouch container or wrapper container at a single temperature, or may be delivered in a box container containing a rack with each food item stored in a customizable temperature zone. At the customer destination, the driver notifies the customer and delivers the goods. If an autonomous vehicle is used, the heating box is locked and the delivery system (e.g., GrubHub™) automatically notifies the customer to retrieve the goods with a code provided via an app or by unlocking the heating box via a mobile device.

In an alternate example, if multiple foods are delivered to multiple customers, the separate food items may be delivered in separate pouch containers or wrapper containers at multiple temperature, or may be delivered in a box container containing a rack with each food item stored in a customizable temperature zone in separate compartments. At each customer destination, the driver notifies each customer and delivers the food items separately. If an autonomous vehicle is used, the heating box is locked and the delivery system automatically notifies each customer to retrieve the separate food items with a code provided via an App or by unlocking the heating box via a mobile device. The code or mobile device can only open the compartment associated with each customer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A container for heating an object comprising:
a top surface;
a bottom surface;
a plurality of side surfaces, wherein the top surface, the bottom surface, and the plurality of side surfaces define an interior of the container in which the object is placed;
a heating shell associated with a first one of the side surfaces, the top surface, or the bottom surface, the heating shell configured to radiate heat into the interior of the container; and
a temperature control module configured to control the amount of heat radiated by the heating shell.

2. The container in claim 1, wherein the heating shell comprises:
an infrared (IR) radiant heating fabric that receives electrical power from the temperature control module and generates heat therefrom.

3. The container in claim 2, wherein the heating shell comprises:
an insulation material that is outermost with respect to the interior of the container, the insulation material adapted to retain heat within the interior of the container.

4. The container in claim 3, wherein the heating shell further comprises:
a heat transmissive cover that is innermost with respect to the interior of the container.

5. The container in claim 4, wherein the infrared radiant heating fabric is disposed between the insulation material and the heat transmissive cover.

6. The container in claim 5, wherein the heating shell further comprises a reflective material disposed between the insulation material and the heat transmissive cover, wherein the reflective material reflects heat toward the interior of the container.

7. The container in claim 6, wherein the infrared radiant heating fabric is disposed between the insulation material and the reflective material.

8. The container in claim 2, wherein the temperature control module generates a pulse width modulated (PWM) waveform, where a duty cycle of the PWM waveform controls the amount of heat radiated by the heating shell.

9. The container in claim 2, wherein the temperature control module further comprises a plurality of temperature setting modules, wherein a first temperature setting module controls the amount of heat radiated by the heating shell.

10. The container in claim 9, further comprising a second heating shell associated with a second one of the side surfaces, to top surface, or the bottom surface, the second heating shell configured to radiate heat into the interior of the container, wherein a second temperature setting module controls the amount of heat radiated by the second heating shell.

11. The container in claim 2, wherein the temperature control module is configured to receive power from an external battery supply.

12. The container in claim 2, further comprising a solar panel, wherein the temperature control module is configured to receive power from the solar panel.

13. The container in claim 2, further comprising an onboard battery, wherein the temperature control module is configured to receive power from the onboard battery.

14. A pouch for heating an object comprising:
a non-rigid fabric material defining an interior of the pouch in which the object is placed;
a heating shell associated with the fabric material, the heating shell configured to radiate heat into the interior of the container; and
a temperature control module configured to control the amount of heat radiated by the heating shell.

15. The pouch in claim 14, wherein the heating shell comprises an infrared (IR) radiant heating fabric that receives electrical power from the temperature control module and generates heat therefrom.

16. The pouch in claim 15, wherein the heating shell comprises an insulation material that is outermost with respect to the interior of the pouch, the insulation material adapted to retain heat within the interior of the pouch.

17. The pouch in claim 16, wherein the heating shell further comprises a heat transmissive cover that is innermost with respect to the interior of the pouch.

18. The pouch in claim 17, wherein the infrared radiant heating fabric is disposed between the insulation material and the heat transmissive cover.

19. The pouch in claim 18, wherein the heating shell further comprises a reflective material disposed between the insulation material and the heat transmissive cover, wherein the reflective material reflects heat toward the interior of the pouch.

20. The pouch in claim 19, wherein the infrared radiant heating fabric is disposed between the insulation material and the reflective material.
